(19) United States
(12) Patent Application Publication
(10) Pub. No.: US 2004/0093310 A1
(43) Pub. Date: May 13, 2004

(54) Transaction system and method

(75) Inventor: Clark Thomborson, Auckland (NZ)

Correspondence Address: NIXON & VANDERHYE, PC, 1100 N GLEBE ROAD, 8TH FLOOR, ARLINGTON, VA, 22201-4714, US

(73) Assignee: Auckland UniServices Limited, Auckland (NZ)

(21) Appl. No.: 10/668,237

(22) Filed: Sep. 24, 2003

(30) Foreign Application Priority Data
Sep. 24, 2002 (NZ) 521555

(51) Int. Cl. G06F 17/60

(52) U.S. Cl. 705/75

(57) ABSTRACT

A method of transacting a digital object in which a vendor offers for sale or trade the digital object to a purchaser, the method comprising the steps of: receiving a digital object from a vendor; testing the digital object for the presence of an authorization code; associating a warning status with the digital object on detecting the presence of an authorization code in the digital object; checking a database of vendor details maintained in computer memory; associating an alert status with the digital object on detecting an entry in the database of vendor details representing an alert status associated with the vendor; adding one or more authorization codes to the digital object; and updating the entry in the database of vendor details representing the vendor with the warning and/or alert status associated with the digital object.

### FIELD OF INVENTION

The invention relates to a transaction system and method, particularly but not solely suited to peer-to-peer marketing of digital objects over the Internet or other electronic marketplace by one or more vendors to one or more purchasers.

### BACKGROUND TO INVENTION

It is becoming increasingly common for traders to use peer-to-peer networks for trading in digital objects, for example graphics and text in formats such as TIFF, GIF, BMP and/or PDF. The use of such a network or networks provides honest vendors more opportunities to sell or trade their creations. It is envisaged that such a network would require some security measures to protect honest vendors from the unscrupulous who might steal digital objects without paying, or who may on-sell digital objects belonging to others without permission.

The most commonly-proposed solution is based on an assumption that all end-users must employ “compliant” or vendor-trusted client systems for viewing, copying and other rights-sensitive manipulations on digital objects obtained from remote servers. Typically such systems encrypt the digital objects, with vendor-trusted encryption keys, whenever these objects are transmitted on untrustworthy channels such as the internet. A good survey of methods employing this solution is found in Chapter 1 of “A Comparative Study of Software Protection Tools Suited for E-Commerce with Contributions to Software Watermarking and Smart Cards”, Gaël Hachez, PhD Thesis, Université catholique de Louvain, 2003. This solution suffers from the existence of “hackers” who publish methods which allow end-users to defeat the security of vendor-trusted client systems.

Another solution to digital rights management is to implement a system of secure authorization codes known as watermarks. Ideal watermarks for this purpose are completely invisible, highly robust and have high information capacity. The installation and embedding of the watermark may be done at a vendor-trusted client system at the end-user's location, rather than at a server. However vendor-trusted clients are inherently insecure, for the reasons described above.

Almost all systems that employ watermarks also employ vendor-trusted client systems. The client system must be trusted to accurately read the watermarks, and to make an appropriate response whenever an infringement is detected or suspected by the watermark detector. A typical response by a vendor-trusted client system is to deny access, whenever its watermark detector signals that an infringement may be occurring. The Content Scrambling System (CSS) of modern DVD players is such a vendor-trusted client system with a watermark detector and a denial-of-service response mechanism. However, for the reasons noted above, any client system that is in the possession of end-users is technically insecure.

The European research initiative OCTALIS has explored the use of watermarks and encryption in digital-rights management systems. Relevant features of the OCTALIS system are disclosed in L Piron et al., “OCTALIS benchmarking: Comparison of four watermarking techniques”, in P W Wong and J Delp (eds.), Security and Watermarking of Multimedia Content 3657, SPIE, 240-250, 1999. To some extent, the security of this system will depend on the trustworthiness of a vendor-trusted client system. In particular, the client system must be trusted not to disclose its decryption keys to its authorised end-users or to third parties.

The security feature of particular importance to the present invention is the traitor-tracing facility of OCTALIS, wherein each digital object is personalised by a server-installed watermark (hereafter “fingerprint”) that uniquely identifies the authorised end-user of this copy of the object. If this fingerprint were not removed by a traitorous end-user who resells their copy in some public arena, and if additionally the author's watermark survived any attempts at removal by the traitorous end-user, then the author of the object may be able to apprehend the traitor by the following means. The author may scan the objects for sale in some public arena. If they detect their watermark on some object in some arena, they may then use the fingerprint (if any is legible) on this object to apprehend the traitor.

This detection is problematic in two regards: the author must scan for their watermark in a wide universe of public arenas, and the detection process is error-prone because the traitorous end-user may modify either their fingerprint or the author's watermark. Both the fingerprint and the watermark must be large (at least 32 bits in length) in an information-theoretic sense, to allow for the many possible combinations of authors and end-users. It is a well understood principle of digital watermarking that the larger the watermark, the lower its resiliency against unauthorised detection and removal. Thus the size of the OCTALIS watermarks and fingerprints places a practical limit on their security.

Hector Garcia-Molina and Narayanan Shivakumar, in their paper “Safeguarding and Charging for Information on the Internet” (Proceedings of ICDE'98, February 1998) have suggested the use of copy-detection instead of large fingerprints, as a means for implementing a traitor-tracing feature in a digital rights management system called SCAM. However the SCAM system of (approximate) copy-detection is implemented only for textual documents. It is not known how to perform approximate copy-detection accurately and automatically on other digital formats.

Existing digital-rights systems are generally designed to protect mass-produced digital objects, such as Hollywood movies or rock music songs. However micro-producers, for example peers in a trading network, have different security requirements than macro-producers. It would be desirable to offer adequate vendor protection in peer-to-peer markets for digital marketplace, without the use of large secret watermarks (as in OCTALIS), copy-detection mechanisms (as in SCAM), or vendor-trusted client systems (as in other existing digital-rights systems).

It would also be desirable to provide some reliable mechanism for a corrective (or punitive) response, if a usage violation is detected by a watermark detector. In systems of practical utility, there should be some oversight or auditing function, to be invoked periodically or whenever it is suspected or alleged that the corrective or punitive response is incorrect either by omission or commission.

### SUMMARY OF INVENTION

In broad terms in one form the invention provides a method of transacting a digital object in which a vendor offers for sale or trade the digital object to a purchaser.

The method includes the steps of receiving a digital object from a vendor, testing the digital object for the presence of an authorisation code and associating a warning status with a digital object on detecting the presence of an authorisation code in the digital object. The method also involves checking a database of vendor details maintained in computer memory and associating an alert status with the digital object on detecting an entry in the database of vendor details representing an alert status associated with the vendor. One or more authorisation codes are added to the digital object and the entry in the database of vendor details that represent the vendor is updated with the warning and/or alert status associated with the digital object.

In another form, the method includes the steps of receiving a digital object from a vendor, testing the digital object for the presence of an authorisation code, and associating a warning status with the digital object on detecting the presence of an authorisation code in the digital object. The method also includes adding one or more authorisation codes to the digital object and updating the entry in the database of vendor details representing the vendor with the warning status if associated with the digital object.

In another form the method includes the steps of receiving a digital object from a vendor, checking a database of vendor details maintained in computer memory and associating an alert status with a digital object on detecting an entry in the database of vendor details representing an alert status associated with the vendor. The method further includes the steps of adding one or more authorisation codes to the digital object and updating the entry in the database of vendor details representing the vendor to the alert status if associated with the digital object.

In broad terms in another form the invention provides a method of transacting a digital object from which a vendor offers for sale or trade the digital object to a purchaser. The method includes the steps of transferring a digital object from a vendor to an electronic marketplace, testing the digital object for authorisation violation, adding one or more authorisation codes to the digital object and storing an identifier of the vendor in computer memory in the event of the digital object violating the authorisation test.

In broad terms in a further form, the invention provides a transaction system in which a vendor offers for sale or trade a digital object to a purchaser. The system includes an acceptance component configured to receive a digital object for sale or trade, a watermarking component configured to create a watermarked object from the vendor submitted object, a recognition component configured to test the digital object for authorisation violation, and an enforcement component configured to store data representing authorisation violation in computer memory.

### BRIEF DESCRIPTION OF THE FIGURES

Preferred forms of the transaction system and method will now be described with reference to the accompanying figures in which:

FIG. 1 illustrates a block diagram of a system in which the invention could operate;

FIG. 2 shows a sample database schema for the vendor database;

FIG. 3 shows an instance of the schema of FIG. 2;

FIG. 4 illustrates operation of the acceptance component from FIG. 1;

FIG. 5 illustrates operation of the recognition component from FIG. 1;

FIG. 6 shows a sample object record definition;

FIG. 7 shows an instance of the schema of FIG. 6;

FIG. 8 illustrates operation of the enforcement component from FIG. 1; and

FIG. 9 shows a sample submission schema.

### DETAILED DESCRIPTION OF PREFERRED FORMS

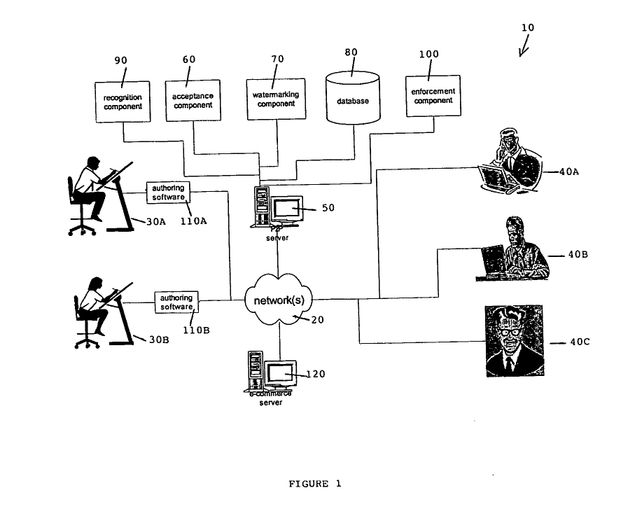

FIG. 1 illustrates a transaction system 10 in which one form of the invention may operate. The system includes a network or combination of networks 20 enabling a vendor, for example an author 30A or 30B to offer to a purchaser, for example 40A, 40B or 40C a digital object for sale or trade. It is envisaged that the digital object could include any electronic object, for example digital encoded images, documents, movies, audio, three-dimensional models of objects, and computer software in executable or source form. It is envisaged that any person or corporation may register as a vendor in database 80, which may be done by supplying appropriate identification (such as name and invoicing address) and credentials. The credentials may include a credit card number or a performance bond that is deposited with the managers of database 80. Any or all of the author(s) or owner(s) of a digital object may register as a vendor. Parties who act as agents for authors or owners may also register.

The preferred network(s) 20 is a peer-to-peer network-based electronic marketplace. It is envisaged that the implementation of such marketplace could differ, but in each case parties, for example authors 30, make their arrangements for trade or sale of digital objects to purchasers 40 or other authors 30. Parties who wish only to act as purchasers 40 need not register as vendors in database 80.

The data stored in database 80 for each vendor should contain sufficient verifiable identifying material to allow its administrators to prevent spurious registrations, such as a single party who registers as a vendor many times in an attempt to defraud the trading system. Each vendor will choose (or alternatively will be assigned by the managers of database 80 in some implementations) a unique digital identity I during the registration process.

Means for authentication of identities I, by database 80, is preferably incorporated in this system. For example the identity I may be a login name, authenticated by a secret password that is chosen during the registration process. Alternatively the identity I may be a “digital certificate” that may be verified by a public key infrastructure as provided by VeriSign. Only a party who knows the private key for I will be able to convince the managers of database 80, that they are indeed authorised to offer goods for sale as I.

The system 10 may include a peer-to-peer server 50 on which is installed and operating software forming part of the invention, for example an acceptance component 60, watermarking component 70, database 80, recognition component 90, enforcement component 100, authoring software components 110, and e-commerce server 120. An author 30 submitting a digital object to the server 50, has this digital object checked for authorization violations. The acceptance component 60 is a software component configured to perform this function. The acceptance component 60 could be implemented on the server 50 or at least interfaced to server 50.

The watermarking component 70 is configured to add one or more authorization codes to the digital object. A digital object which already includes authorization codes is identified by the acceptance component 60 as an authorization violation. Database component 80 stores information such as the identifier of the author 30 in the event that the author submits a digital object violating the authorization test.

It is envisaged that the majority of transactions conducted over system 10 involve easily identifiable and reputation-sensitive corporate entities, rather than anonymous individuals of dubious intent. In such a marketplace, unscrupulous traders need not be identified immediately, nor need they be identified with high probability on each offence. Instead, a low probability of detection will be sufficient to deter corporate piracy, because the perceived legal and economic penalties for any detected offence will be high. A moderate level of individual piracy could be written off as a cost of doing business in the marketplace or be viewed even as a form of advertising expense.

In one form the watermarking component could include a dual watermarking process in which one or more types of authorization codes or watermarks are added to a digital object.

A first such watermarking process could involve the embedding of one or more small, for example one-bit, watermarks in a highly robust, reasonably resilient and highly invisible fashion in a digital object. It is not believed feasible to embed a large, for example 100-bit or 1000-bit, robust, resilient and invisible watermark in a typical digital object, if the watermark detector is made available to the public.

In the single-bit watermark used in this invention, the detector is private, in that only trusted individuals should be given access to the watermark detector and to any secret key that may be required as input to the watermark detector. As is well known, a single-bit has a value selected from two values, usually 0 or 1. For the purposes of the invention, the value 1 signifies that the digital object was obtained from the marketplace of the invention and the value 0 has the meaning that the digital object was not obtained from the marketplace. It is envisaged that this watermark could employ any available technique for private one-bit robust watermarking.

As noted above, the preferred watermark is a private one-bit watermark, because private watermarks are inherently more resilient to attack than public watermarks, and because one-bit watermarks are inherently more resilient to attack than watermarks with higher information capacity such as 100 bits. Those skilled in the art of digital watermarking will understand that means for the implementation of a private one-bit watermark will depend on the format of the digital object.

In the case that the digital object is a digitally-represented image or sequence of images, suitable means have been disclosed in many publications, for example in Moskowitz et al. U.S. Pat. No. 5,905,800, in Isnardi et al. U.S. Pat. No. 6,037,984, and in V. Roth et al., “Improved Key Management for Digital Watermark Monitoring”, Proc. SPIE Vol. 4675, pp. 652-8, 2002. The means of V. Roth et al. include the use of a feature vector extracted from the digital object; in the present invention this feature vector would be stored in database 80 when the object is watermarked by watermarking component 70.

In the case that the digital object is a digitally-represented audio signal, suitable means have been disclosed in many publications, for example in Rhoads U.S. Pat. No. 6,122,392 and in Cox et al. U.S. Pat. No. 6,154,571.

In the case that the digital object is software, suitable means have been disclosed in several publications, for example in Collberg et al., published international patent application WO 99/64973.

In the case that the digital object is formatted text, such as a file in PDF or PostScript format, suitable means have been disclosed in several publications, for example in Brassil et al., “Electronic Marking and Identification Techniques to Discourage Document Copying”, IEEE J. Sel. Areas in Communications 13:8, October 1995.

In the case that the digital object is unformatted text, and in situations where the textual content (rather than its formatting) is deemed to be worthy of careful protection, a feature vector should be stored in database 80 when the object is watermarked by watermarking component 70, so that a non-blind watermarking or approximate copy-detection algorithm may be employed by the watermark detector in recognition component 90; a survey of such methods is published in Finkel et al., “Signature Extraction for Overlap Detection in Documents”, in Proc. Twenty-Fifth Australasian Computer Science Conference, 2002.

In the case that the digital object is a 3D object, suitable means have been disclosed in several publications, for example in R. Ohbuchi et al., “Embedding data in 3D Models”, in Proc. IDMS '97, LNCS 1309, Springer, 1997; and in O. Benedens, “Robust Watermarking and Affine Registration of 3D Meshes”, in Proc. IH 2002, LNCS 2578, Springer, 2003.

Those skilled in the art of digital watermarking will understand that no watermarking method is completely resilient from attacks by a well-resourced adversary who seeks to obliterate or alter the watermark. Furthermore, no watermarking detector is completely accurate, so any means for digital rights management that relies on watermarks must make adequate provision for false-positives as well as false-negatives. In a false-positive report by a watermark detector, an object that does not contain a watermark is improperly asserted to contain this watermark. In a false-negative report by a watermark detector, an object that does contain a watermark is improperly asserted to be unmarked. The present invention offers suitable means for the protection of digital rights, despite these known imperfections in the technical means for watermarking.

A second watermarking process would be incorporated in a preferred embodiment, so that objects would be protected by dual watermarks. The second watermark is used as a signature watermark, and would contain 100 bits or more of information to identify an object's author and any licensing restrictions. This watermark would be public, that is, it would be readable by authors 30.

It is well known how to embed signature watermarks in digital objects, for purposes of digital rights management; suitable means for objects of various formats are disclosed in the publications listed above and are surveyed in Miller et al., Digital Watermarking: Principles and Practice, Morgan Kaufmann, 2001. Signature watermarks in complex digital objects are reasonably secure against adversarial attack, in systems where the secret “key” required to implant and extract the watermark is disclosed only to trusted individuals. Those skilled in the art of watermarking will understand that a public 100-bit watermark cannot be expected to withstand a sustained adversarial attack. For this reason the present invention includes means for the provision of adequate security despite this known limitation in the technical means for watermarking.

Signature watermarks are sometimes called “rights management information” or “copyright management information” for example in Section 1202 of the WIPO Copyright Treaty. This alternative terminology suggests (appropriately) that the information will become detached from the underlying object, whenever the technological, legal and social impediments to such detachments are inadequate. The present invention may be used with any system or component for the authoring, negotiation and interpretation of rights management information such as those disclosed in Stefik et al. U.S. Pat. No. 5,634,012; Johnson et al. U.S. Pat. No. 5,991,876; and Kahn et al. U.S. Pat. No. 6,135,646. It is envisaged that, in some implementations of the present invention, database 80 will contain records of vendors, purchasers, licenses, and objects which will be updated whenever individual licenses are negotiated or amended. In other implementations, database 80 will neither be consulted nor updated in such negotiations.

In existing copyright marking and other digital rights management schemes, the secret key for signature watermarks is embedded in widely distributed computer hardware or software, or alternatively the general public is given high-bandwidth low-latency access to a signature watermark decoder held in a secure centralised location. All signature watermarks in such schemes are thus susceptible to attack by parties, such as artist 30b in FIG. 1, who may be untrustworthy. In the present invention, however, even if an artist 30b employs a “cracking” technique that successfully removes the signature watermark without damaging the digital object, the highly robust one-bit watermark is overwhelmingly likely to remain intact. The continued presence of the one-bit watermark in digital objects will, in the manner described below, provide ongoing marketplace security even when signature watermarks are compromised.

In a preferred form, the one-bit watermark has the additional property that it should be resilient to dissection attacks where the attacker cuts the marked object into several pieces, modifies each piece slightly, perhaps only imperceptibly, then reassembles the object. The desired one-bit watermark would be present with significant probability in the reassembled object. Many of the watermarking means disclosed in the publications listed above will provide some protection against a dissection attack, however those skilled in the art of watermarking will understand that a determined adversary will have at least a moderate probability of success in a dissection attack. Such attacks will increase the false-negative error rate of the watermark detector in the present invention (or in any other system relying on watermarks). As previously noted, the present invention includes means for providing adequate security even when the detector gives a false-negative response.

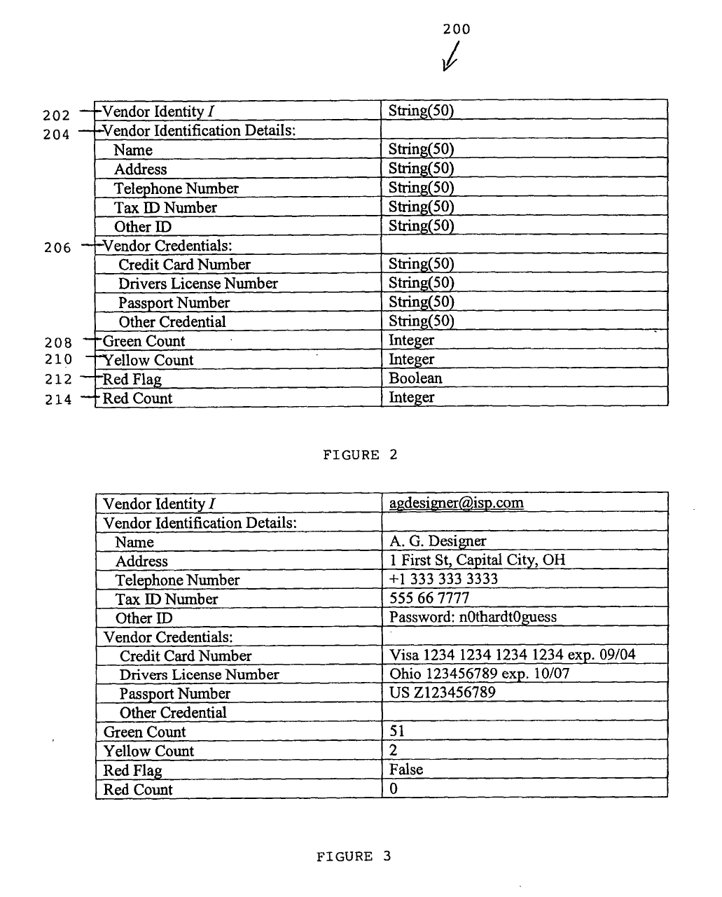

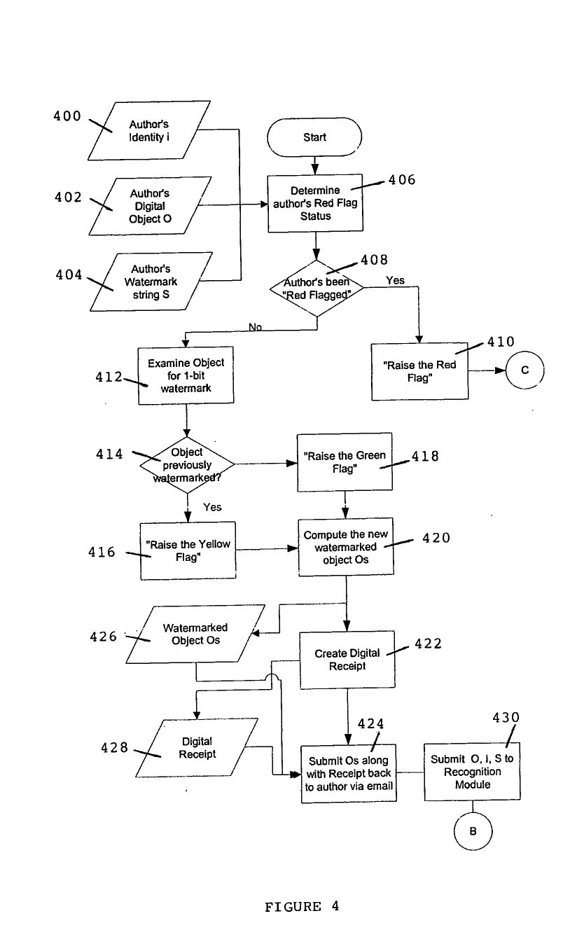

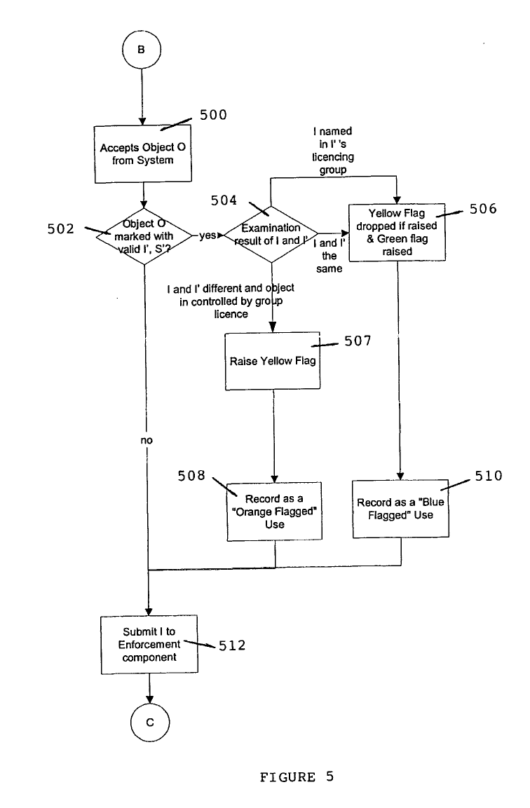

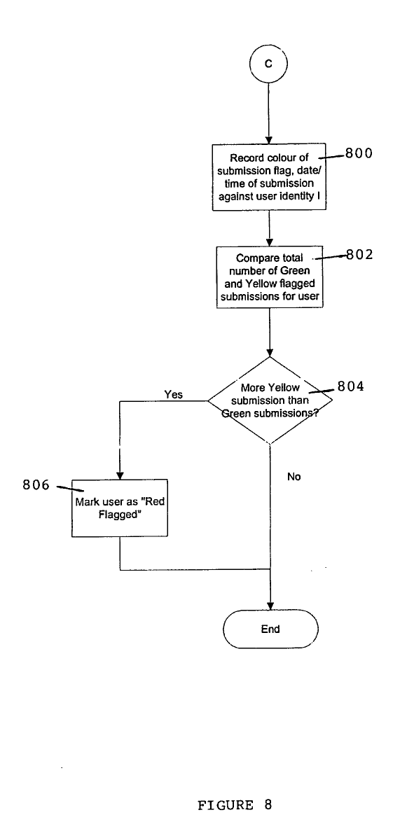

The operation of the transaction method of the invention is now described with reference to a specific example shown in FIGS. 2 to 9. FIGS. 2 and 3 illustrate a preferred form database schema for database 80. FIG. 4 illustrates operation of the acceptance component 60 from FIG. 1, FIG. 5 illustrates operation of the recognition component 90 from FIG. 1, and FIG. 8 illustrates operation of the enforcement component 100 from FIG. 1.

Referring to FIG. 2, a record 200 is created in database 80 for each registered identity I during registration. In some database implementations, it would be efficient or necessary to use a database-assigned unique integer vendor ID (not shown) as a primary key to record 200. It is envisaged, however, that a unique vendor identify I indicated at 202 serve as the primary key. Record 200 could also contain personal identifying details 204 of the vendor, author, or other authorised person, such as name, address, telephone number, tax ID number and/or other ID. Record 200 could also include vendor credentials 206 such as a credit card number, drivers licence number, passport number and/or other credentials.

Record 200 could also include integer fields “Green Count” 208 and “Yellow Count” 210, the purpose of which is explained below.

Record 200 could also include a Boolean red flag field 212 and optionally a “Red Count” integer field 214. A value of true in red flag field 212 indicates that vendor identity I indicated at 202 is deemed to be “red flagged”, otherwise identity I is not red flagged.

FIG. 3 illustrates a sample vendor record that could be stored in the database 80. One example of vendor identity I could be an email address and/or password combination. It would be appreciated that different combinations of alpha-numeric characters could be used as vendor identity I.

Referring to FIG. 4, an author, vendor or other authorised person obtains 400 a unique digital identity I from the server 50 of the invention, in an initial registration step. In a preferred embodiment, this identity would be established when the author obtains a valid licence to use any compliant 3D object authoring software.

Using suitable authoring software, the author creates 402 an original object O and also creates 404 a watermark string S. A typical character string could specify conditions of use, licensing and/or subsequent sale.

The author submits identity I, object O and character string S to the server 50. This submission could be made either by web service or by email at the convenience of the author. The string S includes any rights management information desired by the author, for example an author may (at their option) include in S a reference to a license that is administered by some digital rights management system such as that disclosed in Stefik et al. U.S. Pat. No. 5,634,012. In this case server 50 may act as a Repository as defined in U.S. Pat. No. 5,634,012, in addition to performing the functions disclosed in the present invention.

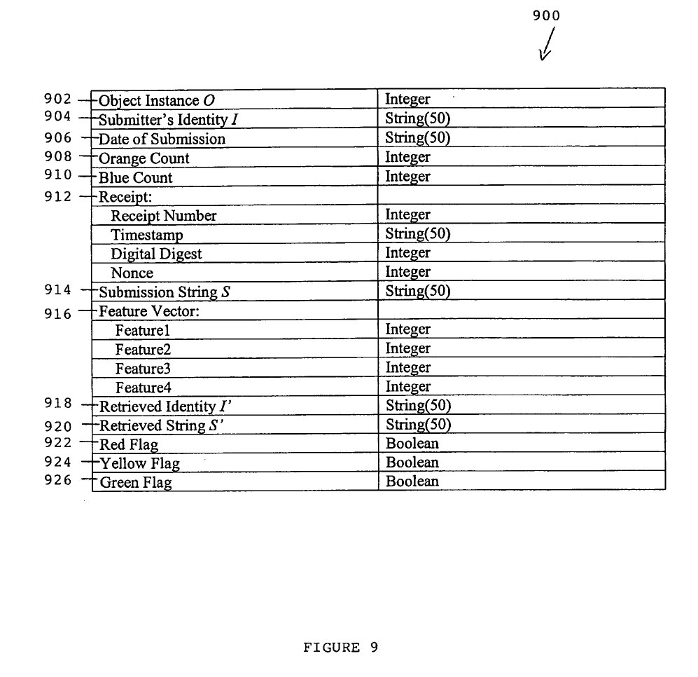

Upon receipt of each submission, server 50 could a temporary record. An example temporary record representing a current submission is described below with reference to FIG. 9.

Referring again to FIG. 4, the author's status is checked 406 against database 80 containing identifying details of authors as noted above, including their red-flag status 212. If the submitting author is one who has been red-flagged 408, the server 50 could optionally raise 410 a red flag on the current submission of the author by setting the Red flag field to True, and control is passed to the further steps outlined in FIG. 8 below.

If the author has not been red-flagged, the digital object is tested for authorization violation. In one form, the object could be examined 412 for the presence of an existing watermark, for example the one-bit watermark.

If the object carries the one-bit watermark 414, then the acceptance component 60 raises 416 a “yellow flag” warning signal. It is preferred that the author 30 receives no immediate information about the presence or absence of this yellow flag signal. To do so would greatly lower the resiliency of the one-bit watermark.

Any immediate signal to the submitting artist would be equivalent to providing a public watermark recognition service for the private one-bit watermark. Such a service could be abused by an attacker, who could have a non-trivial chance of learning a transformation that reliably removes the one-bit watermark, in a series of interactions with the public recognition service. Each interaction could be short enough to preserve the attacker's anonymity with high probability.

If the object does not carry a watermark, then the acceptance component raises 418 a “green flag” signal without disclosing the signal to the author 30.

Regardless of whether a green or yellow flag is raised by the acceptance component 60, the acceptance component passes the submitted object O and the string S to the watermarking component 70. The watermarking component computes 420 a new watermarked object Oₛ by embedding a one-bit watermark using the first watermarking technique. In a preferred embodiment, a second signature watermark is also embedded in Oₛ. The signature watermark contains a compressed version of the character string S and the identity I into the object O using the second watermarking technique described above.

In one preferred form, the compression algorithm will be designed to carry the most likely character strings in the least number of bits. For example, the introductory phrase “this object belongs to” could be compressed into a few bits in a preferred embodiment wherein the submitting artist is prompted to start their character string with this phrase. A short, for example 16-bit, digital signature could be computed over the identity I and the compressed representation of the string S in a manner known to those of ordinary skill in the art of data communications, so that a “string and identity valid” signal V may be produced when the watermark is recognised.

If a submitting artist subsequently resubmits the marked object Oₛ, or any modification of Oₛ, to the acceptance component 60, the acceptance component will raise the “yellow flag” as described above in step 416.

The next step is to create 422 a digital receipt and after a suitable delay, preferably for at least a few seconds to prevent high bandwidth attacks on the watermark embedding process, submit 424 the watermarked object Oₛ 426 and digital receipt 428 back to the author. The preferred form digital receipt 428 includes a time stamp, a nonce value, and a digital digest of 32-bits or longer of the originally submitted object O. In the case that the submitted string S contains “usage rights” in the sense specified by Stefik U.S. Pat. No. 5,634,012, then the server 50 may act as a Repository as disclosed by that patent. Similarly, in the case that the submitted string S contains “rights management information” in the sense specified by Kahn U.S. Pat. No. 6,135,646, then the server 50 may act as a “Registration System” in the sense specified by that patent.

A “nonce” as used in the description serves to disambiguate multiple certificates with otherwise identical contents. Typically, the value of a nonce is either a sequence number assigned sequentially by the submitter or the server, or is chosen by a pseudo-random process. The submitter might use a sequence-number nonce as a convenient reference to submissions, alternatively or additionally the watermarking system might sequence-number submissions to detect certain forms of fraud. Alternatively or additionally, the water-marking system or submitter might use a pseudo-random nonce, where the pseudo-random generator is initialised with a secret “seed” value, to detect that someone has created a fraudulent certificate.

In a preferred embodiment, the originally submitted object O is submitted 430 to the recognition component 90 of server 50. The recognition component 90 may be omitted from server 50 if signature watermarks are not employed by the system.

Referring to FIGS. 1 and 5, the recognition component 90 accepts 500 object O, submitter I and licensing string S from the acceptance component 60. The recognition component extracts 502 an identity I′ and a licensing string S′ from the signature watermark, along with a validity signal V′. If the extracted information is valid (V′=1) then 504 the recognition component compares the submitter's identity I to the identity I′ extracted from the submitted object O. If the submitter's identity I is the same as the extracted identity I′, then the yellow flag is dropped 506 if it has been raised in an earlier step and has not already been dropped, and the green flag is raised for this submission of the author.

In one form, the test 504 could simply be whether I and I′ are identical. Alternatively, the recognition component could recognise “group licences” where each group comprises a set of identities registered with the server 50. Submissions of an object by an identity named in the licence group of that object will result in the dropping of the yellow flag if currently raised and the raising of a green flag on the submission. An agent for an author, or other authorised person, could be included in the same licence group as the author.

If the object owner I′ is different to the submitter identity I, then alternatively where the submission of object O is not permitted to submitter I under the terms of their licence for object O, then the yellow flag on this submission is raised 507 if it is not already yellow. The yellow flag is an indication of a licence violation.

In a preferred embodiment this licence violation is transmitted 508 to the database component 80, or another database component, to modify a database record that was created when each object O is submitted.

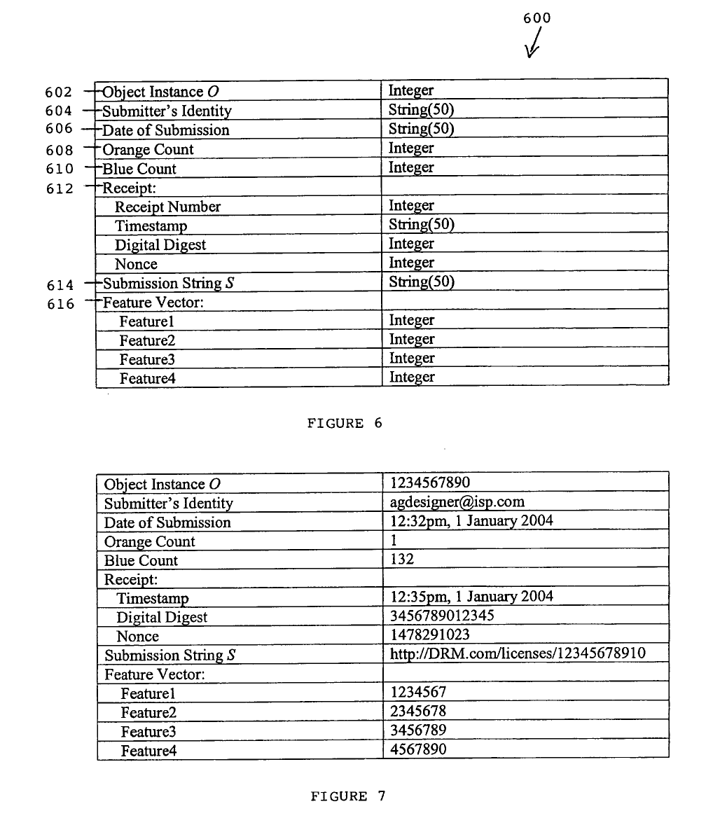

FIG. 6 illustrates a preferred form schema for a record 600 that could be created when an object O is submitted. The typical record 600 would include an object instance O indicated at 602, a submitter ID field 604 and date of submission field 606. It is envisaged that the record 600 also include “Orange Count” field 608 and “Blue Count” field 610 that are incremented depending on whether or not orange-flagged use of object O is detected.

Optional fields in record 600 could include receipt fields 612 that include a receipt number, time stamp, digital digest and nonce, a submission string S indicated at 614 and feature vector fields 616. The length of the feature vector 616 could be adjusted to any convenient length.

FIG. 7 illustrates an instance of record 600 from FIG. 6. The object instance number O could conveniently be a unique integer that is assigned by the database system when the object is submitted by a vendor I. This instance number would conveniently serve as a primary key for this record in a relational database. Alternatively, the digital digest field could be used as a primary key, as the probability of this field not being unique is extremely small.

The Orange count 608 of an object O is incremented 508 whenever an orange-flagged use of O is detected. Alternatively, the Blue count 610 of this object is incremented 510.

In some embodiments the database record for object O would additionally include a copy of the string S as submitted with object O, a copy of the Receipt returned to the submitting author in step 424, and identifying information such as a feature vector for the object O or a digital hash of its contents any of which may be used in watermark recognition or approximate matching or investigations by the managers of system 50. Identity I is then submitted 512 to Enforcement component 100.

Referring to FIGS. 1 and 8, the final colour of the submission flag (red, yellow or green) is transmitted 800 by the enforcement component 100 to the database component 80, for storage in the database record of the submitter's identity I.

The database 80 maintains running totals of the colours of flags indexed by identity I, in the Yellow Count 208 and Green Count 210 integer fields of I's database record. In some implementations database 80 could also contain a Red Count integer field 214 in I's database record so that a total number of red-flagged submissions may also be recorded. These totals are tested and compared 802 whenever an author with an identity I makes a submission. If the Yellow Count 210 significantly exceeds 804 the Green Count 208, then the identity I of the author is “red flagged” 806 by setting their Red Flag field 212 to a “True” value. In some forms, the string S and a digital digest of the submitted object O are also recorded in I's database record, extending a list of objects previously submitted by I. In the envisaged form, a list of all objects submitted by I may be created at any desired time, by running a database query on Object records (FIG. 3) whose Submitter's Identity 604 matches I. This list of submissions may be used in investigations by personnel managing the server 50.

FIG. 9 illustrates an example temporary record 900 representing a current submission. The record 900 could be used to keep track of the information in the current submission. Information in this record could be manipulated by the algorithms described above.

The record 900 could include an object instance O field 902, submitter's identity I field 904, date of submission 906, “Orange Count” field 908 and “Blue Count” field 910.

The record 900 could also include receipt fields 912, submission string field 914, feature vector fields 916, retrieved identity I′ field 918, retrieved string S′ 920, red flag field 922, yellow flag field 924 and green flag field 926.

The server 50 could provide a summary report of some of the information in the database component indexed by I to anyone who authenticates as digital identity I. If the identity is not red-flagged 212, the summary report could include the total number of object submissions made by identity I, a rough (low-precision) approximation to the ratio of the integers counting the Yellow 210 and Green 208 flagged submissions made by identity I, a rough (low-precision) indication of the total orange 608 and blue 610 flagged submissions of objects bearing the watermark of I, and the time and date of the last summary report, if any. The precision of the reports on the Yellow/Green ratio and of the Orange and Blue counts should be carefully chosen, as a balance between preserving the security of the private one-bit watermark and giving adequate disclosure to vendors I. In an envisaged application of this invention, the ratio would be reported in three bands: less than 33%, less than 67%, and less than 100%. In this envisaged application the counts would be reported to less than one significant figure in scientific notation, that is, in bands demarcated by the integer sequence 10, 100, 1000, 10000, etc. For additional security, the counts would be multiplied by a pseudo random number uniformly distributed in the range [0.8, 1.3] before they are reported, the database record for identity I would be augmented by the date and approximate counts of the last report, reports would be limited to one per week, and the approximate counts reported would always be in ascending order even though the pseudo random multiplier might otherwise result in a non-monotonic series of counts.

Continuing with the description of the optional reporting process of server 50 as requested by identity I, if the identity I is red-flagged, this is disclosed in the report. The response to any request for a summary report should be made by email with a one week time delay in a preferred form. The maximum frequency of reporting to any individual could also be limited to one report per week in a preferred form, and this limitation could be enforced by recording the date of the last report in the record stored in database 50 for each identity I. These limitations on reporting are an attempt to maintain the security of the one-bit watermark.

An individual noticing a great excess of orange flags over blue flags recorded against their identity I may request an investigation of the suspected fraud. Investigations of suspected fraud could be partially or wholly automated. The investigation may result in the server 50 raising a red flag 212 against identities who have made orange flagged submissions of objects that are marked as being owned by author with identity I.

Any red-flagged 212 identity may request an investigation of their status at any time within limits that are imposed to protect the operators of the server 50 from harassment by repetitive requests from a single identity. Such status investigations could be partially or wholly automated, depending in part upon the amount and variety of evidence, for example digital receipts, verbal explanations, character testimonials, etc that are submitted by the red flagged identity to justify their activity.

The invention described above preferably provides for confidentiality. Transactions with server 50 are conducted by digital identity only. Users may choose to reveal or conceal their physical identity on the objects they distribute, when they design their licence information strings S. It is envisaged that lists of red-flagged identities are not published, however to protect other authors, the server 50 could refuse to provide further service to such red flagged individuals.

All transactions are indexed by digital identity which a concerned submitter may protect by cryptographic and other means. In a preferred form, the invention would support all identity authentication standards in common use. For example, the system could be designed to accept and validate the X.509 digital signature of a submitter, and to accept the Kerberos ticket of another submitter. This technology enables the detection and prevention of violations of integrity of submitters of digital objects. Any person who modifies a watermarked object, and submits the modified object to the server 50 for distribution, is liable to be detected and red flagged.

A compliant object authoring software product 110A 110B in a preferred embodiment would have the capacity to read one or more of the variant signature watermarks that may be found on objects O that were previously watermarked by watermarking component 70. When a compliant authoring software product 110A reads a valid watermark on an object being edited, the user interface of product 110A would display a human-readable form of the string S and the identity I of the owner of object Oₛ. The user interface may additionally offer licence-compliance and order-fulfilment services, such as making a web-connection to an e-commerce server that offers licence contracts and collects payments when the terms of licence contracts have been accepted. The e-commerce server may be an additional component 120 of P2P server, alternatively the e-commerce server may be implemented in a separate computational and storage facility attached to the world-wide web or other network 20.

The system is susceptible to denial of service attacks similar to other web-enabled services. Those knowledgeable in the art of network security may use standard techniques to lessen the susceptibility. Additionally, the service could be less susceptible to attack because of the time delays designed into the service response times.

The foregoing describes the invention including preferred forms thereof. Alterations and modifications as will be obvious to those skilled in the art are intended to be incorporated within the scope hereof, as defined by the accompanying claims.

1. A method of transacting a digital object in which a vendor offers for sale or trade the digital object to a purchaser, the method comprising the steps of:
receiving a digital object from a vendor;
testing the digital object for the presence of an authorization code;
associating a warning status with the digital object on detecting the presence of an authorization code in the digital object;
checking a database of vendor details maintained in computer memory;
associating an alert status with the digital object on detecting an entry in the database of vendor details representing an alert status associated with the vendor;
adding one or more authorization codes to the digital object; and
updating the entry in the database of vendor details representing the vendor with the warning and/or alert status associated with the digital object.

2. A method of transacting a digital object as claimed in claim 1 further comprising the steps of:
receiving a vendor identifier representing the vendor from which the digital object is received; and
adding the vendor identifier to the digital object.

3. A method of transacting a digital object as claimed in claim 2 further comprising the steps of:
extracting the vendor identifier from the digital object;
comparing the extracted vendor identifier with the vendor identifier received from the vendor; and
checking the digital object for an associated warning status.

4. A method of transacting a digital object as claimed in claim 3 further comprising the step of removing the warning status if the extracted vendor identifier matches the vendor identifier received from the vendor.

5. A method of transacting a digital object as claimed in claim 3 further comprising the step of associating a warning status with the digital object if the extracted vendor identifier does not match the vendor identifier received from the vendor.

6. A method of transacting a digital object as claimed in claim 1 further comprising the steps of:
checking the database of vendor details maintained in computer memory; and
updating the entry in the database of vendor details representing the vendor with an alert status if the number of warning status indicators associated with the vendor exceeds a predefined threshold.

7. A method of transacting a digital object in which a vendor offers for sale or trade the digital object to a purchaser, the method comprising the steps of:
receiving a digital object from a vendor;
testing the digital object for the presence of an authorization code;
associating a warning status with the digital object on detecting the presence of an authorization code in the digital object;
adding one or more authorization codes to the digital object; and
updating the entry in the database of vendor details representing the vendor with the warning status if associated with the digital object.

8. A method of transacting a digital object as claimed in claim 7 further comprising the steps of:
receiving a vendor identifier representing the vendor from which the digital object is received; and
adding the vendor identifier to the digital object.

9. A method of transacting a digital object as claimed in claim 8 further comprising the steps of:
extracting the vendor identifier from the digital object;
comparing the extracted vendor identifier with the vendor identifier received from the vendor; and
checking the digital object for an associated warning status.

10. A method of transacting a digital object as claimed in claim 9 further comprising the step of removing the warning status if the extracted vendor identifier matches the vendor identifier received from the vendor.

11. A method of transacting a digital object as claimed in claim 9 further comprising the step of associating a warning status with the digital object if the extracted vendor identifier does not match the vendor identifier received from the vendor.

12. A method of transacting a digital object as claimed in claim 7 further comprising the steps of:
checking a database of vendor details maintained in computer memory;
associating an alert status with the digital object on detecting an entry in the database of vendor details representing an alert status associated with the vendor; and
updating the entry in the database of vendor details representing the vendor with the alert status if associated with the digital object.

13. A method of transacting a digital object in which a vendor offers for sale or trade the digital object to a purchaser, the method comprising the steps of:
receiving a digital object from a vendor;
checking a database of vendor details maintained in computer memory;
associating an alert status with the digital object on detecting an entry in the database of vendor details representing an alert status associated with the vendor;
adding one or more authorization codes to the digital object; and
updating the entry in the database of vendor details representing the vendor with the alert status if associated with the digital object.

14. A method of transacting a digital object as claimed in claim 13 further comprising the steps of:
receiving a vendor identifier representing the vendor from which the digital object is received; and
adding the vendor identifier to the digital object.

15. A method of transacting a digital object as claimed in claim 14 further comprising the steps of:
extracting the vendor identifier from the digital object;
comparing the extracted vendor identifier with the vendor identifier received from the vendor; and
checking the digital object for an associated warning status.

16. A method of transacting a digital object as claimed in claim 15 further comprising the step of removing the warning status if the extracted vendor identifier matches the vendor identifier received from the vendor.

17. A method of transacting a digital object as claimed in claim 15 further comprising the step of associating a warning status with the digital object if the extracted vendor identifier does not match the vendor identifier received from the vendor.

18. A method of transacting a digital object as claimed in claim 13 further comprising the steps of:
testing the digital object for the presence of an authorization code;
associating a warning status with the digital object on detecting the presence of an authorization code in the digital object; and
updating the entry in the database of vendor details representing the vendor with the warning status if associated with the digital object.

19. A method of transacting a digital object in which a vendor offers for sale or trade the digital object to a purchaser, the method comprising the steps of:
transferring a digital object from a vendor to an electronic marketplace;
testing the digital object for authorization violation;
adding one or more authorization codes to the digital object; and
storing an identifier of the vendor in computer memory in the event of the digital object violating the authorization test.

20. A transaction system in which a vendor offers for sale or trade a digital object to a purchaser, the system comprising:
an acceptance component configured to receive a digital object for sale or trade;
a watermarking component configured to create a watermarked object from the vendor submitted object;
a recognition component configured to test the digital object for authorization violation; and
an enforcement component configured to store data representing authorization violation in computer memory.
